(19) United States
(12) Patent Application Publication
(10) Pub. No.: US 2018/0260860 A1
(43) Pub. Date: Sep. 13, 2018

(54) A COMPUTER-IMPLEMENTED METHOD AND SYSTEM FOR ANALYZING AND EVALUATING USER REVIEWS

(71) Applicants: Giridhari Devanathan, Mugalivakkam, Chennai (IN); Shyamsunder Ramakrishnan, Chembur, Mumbai (IN); Devendra Singh Sachan, Kondapur, Hyderabad (IN); Sai Kiran Tai Reddy, Ameerpet, Hyderabad (IN)

(72) Inventors: Giridhari Devanathan, Mugalivakkam, Chennai (IN); Shyamsunder Ramakrishnan, Chembur, Mumbai (IN); Devendra Singh Sachan, Kondapur, Hyderabad (IN); Sai Kiran Tai Reddy, Ameerpet, Hyderabad (IN)

(21) Appl. No.: 15/759,422

(22) PCT Filed: Nov. 17, 2015
(86) PCT No.: PCT/IN2015/000428

§ 371 Date: Mar. 12, 2018

(30) Foreign Application Priority Data
Sep. 23, 2015 (IN) 5089/CHE/2015

(51) Int. Cl. G06Q 30/02; G06N 99/00; G06F 17/30

(52) U.S. Cl. CPC G06Q 30/0282; G06N 99/005; G06F 17/277; G06F 17/30719; G06F 17/30707

(57) ABSTRACT

A computer-implemented method for evaluating user reviews over distributed documents of a product comprising the steps of: [STEP 1] extracting and analyzing of user reviews using sentiment engine; [STEP 2] aggregating/annotating the output of sentiment engine analysis; and [STEP 3] displaying the annotated output in a tree-map visualization.

### FIELD OF INVENTION

The present invention relates generally to the field of accessing and analyzing information resources and, more particularly, to method and automated system for performing consumer research which involve analyzing and evaluating the responses of consumers or of the relevant audiences to consumer products or other items by interpreting the information in user reviews, using natural language processing, machine learning (clustering) and data visualization techniques.

### BACKGROUND ART

Today, a huge amount of information is available in online documents such as web pages, newsgroup postings, and online news databases. Among the different types of information available, one useful type is the reviews or opinions, that people express towards a subject. Thus there is a natural desire to detect and analyze sentiments within online documents such as, instead of making special surveys with questionnaires. In addition, it might be crucial to monitor such online documents, since, they sometimes influence public opinion, and negative rumors circulating in online documents may cause critical problems for some organizations. However, analysis of favorable and unfavorable opinions is a task requiring high intelligence and deep understanding of the textual context, drawing on common sense and domain knowledge as well as linguistic knowledge. The interpretation of opinions can be debatable even for humans.

Conventional systems may define relevancy as the number of hits, the number of checkouts and other past and behavioral information gathered for user activity. In some instances, a simple input, or score, from the user is collected and summarized as a number or another set of symbols like ‘stars’. However, for most people, this type of scoring, or relevancy, of the inquiry or search result lacks the specific information that would most benefit the user. To complicate the issue further, finding relevant information has become increasing more difficult with the sheer volume of information now available on the internet combined with the information being made available on a daily basis on internet and other systems.

Though well-designed surveys can provide quality estimations, they can be costly especially if a large volume of survey data is gathered. A technique to detect favorable and unfavorable opinions toward specific subjects, such as organizations and their products, within large numbers of documents and reviews offers enormous opportunities for various applications. It would provide powerful functionality for competitive analysis, marketing analysis, and detection of unfavorable rumors for risk management.

In the prior art, US specification U.S. Pat. No. 6,742,003, issued to “Microsoft Corporation” discloses apparatus and accompanying methods for visualizing clusters of data and hierarchical cluster classifications. In another prior art another US specification U.S. Pat. No. 7,249,312 issued to “Intelligent Results” discloses method for attribute scoring for unstructured contents. US patent US20050091038, issued to “Jeonghee Yi” provides details method and for extracting opinions from text documents. Further prior arts include US20050125216, issued to “Chitrapura Krishna P” for method for extracting and grouping opinions from text documents, US20060200341 & US20060200342 issued to “Microsoft Corporation” disclosing system and method for processing sentiment-bearing text.

While user reviews have existed ever since the advent of the internet and online commerce, and they have always been a rich source of product information, their utility is being undermined because the sheer variety and volume of said user reviews has grown beyond the capacity of the human mind to process this information meaningfully. There needs to be a better way to analyse, summarize and visualise this information so that the primary objective of user reviews is attained (i.e. to inform users about benefits/drawbacks of a product with a view to helping them decide which product to buy).

In the prior art following patent literature has been referred:
1. U.S. Pat. No. 9,037,464, May 19, 2015. Mikolov et al, Computing numeric representations of words in a high-dimensional space.
2. U.S. Pat. No. 8,892,422 B1, Nov. 18, 2014. Shailesh et al, Phrase Identification in a sequence of words.

In the prior art following further non patent and patent literature has been referred:
3. Arthur D. and Vassilvitskii, S. “k-means++: the advantages of careful seeding”. ACM-SIAM symposium on Discrete algorithms. 2007
4. C. D. Manning, P. Raghavan and H. Schütze, Introduction to Information Retrieval. Cambridge University Press, pp. 234-265. (2008)
5. D. Gillick, Sentence Boundary detection and the problem with U.S., NAACL (2009)
6. Sasha Blair-Goldensohn, Building a sentiment summarizer for local service reviews (2008)
7. Quoc V Le, Distributed Representations of Sentences and Documents, (2014)

Therefore there is need of a solution for mining the insights from enormous information in user reviews by using an automated system, and these insights can be presented in an easily-understandable visual manner to the user—thereby allowing him or her to instantly receive the full depth of knowledge and information about a product (as contained in its reviews), without having to manually process all the information.

### SUMMARY OF INVENTION

User reviews have been an ubiquitous fixture ever since the advent of online commerce and user-generated content on the internet. They perform the very important function of informing consumers about the benefits/drawbacks of a product and help them decide whether (or not) to buy a product/service. However, the system of user reviews suffers from the following major drawback:

### Disadvantages in the Existing Approach

Information overload: The existing system of displaying all the reviews generates more information than the mind can comprehend meaningfully in a relatively short time. Users are unable to understand—(1) the various features or aspects of a product, and (2) how the product will perform along those dimensions. Thus, the primary purpose of a user review itself is defeated.
Lack of comprehensiveness: While user ratings do exist for many user reviews, they lack the comprehensiveness and details of a review, and with their implicit meaning leaves users in a difficult spot when they have to decide which product to buy.
Lack of reliability: User ratings are more prone to manipulation than user-reviews since it is easier to submit a rating than to write an entire review, and it is easier for the end user to identify a fake review as against a fake rating.

In one embodiment, the disclosed method is configured for analyzing user-generated content and user data to understand the sentiment using natural language processing.

A pipeline is described herein for the analysis of reviews which includes steps like preprocessing of the reviews to clean them, identify key-phrases from the reviews, sentence boundary detection, semi-supervised labelling of reviews, training machine learning classifier to compute the prediction scores and computing the sentiment scores of reviews.

A method is presented to do the aspect and sentiment based text-clustering of reviews which are displayed in treemap view for every category of items.

Therefore such as herein described there is provided a method for interpreting the information in user reviews, using natural language processing, machine learning (clustering) and data visualization techniques—all incorporated into a single automated system. Our approach overcomes the drawbacks of information overload in user reviews, by automatically mining information from the entire body of reviews, aggregating, grouping this information and displaying it using easily comprehensible visualisation techniques like treemaps. It therefore offers the following benefits

1. Saves time for consumers: The problem of information overload is overcome because users are now able to interpret all the information at a glance, instead of having to spend endless hours sifting through reviews in search of information. Our algorithm automatically captures meaningful information from the reviews and then aggregates, groups and sorts that information to display it to users in an easily consumable form.

2. Retains comprehensiveness and reliability: Since the entire body of reviews is used for analysis purposes, there is no loss of information, comprehensiveness or reliability (as is the case when user-ratings are used to interpret information).

3. Improves the user experience: By allowing the user to view all the information at a single glance in an easily understood format, the user experience is improved.

In another embodiment there is provided a computer program product comprising at: least one non-transitory computer-readable medium containing program instructions that can be executed by a computer or other device, causing it to perform a disclosed method essentially as described herein.

Before the present methods, systems and materials are described in detail, it is to be understood that this disclosure is not limited to the particular methodologies, systems and materials described, as these may vary. It is also to be understood that the terminology used in the description is for the purpose of describing the particular versions or embodiments only, and is not intended to limit the scope.

### BRIEF DESCRIPTION OF THE ACCOMPANYING DRAWINGS

FIG. 1 illustrates a flow diagram of one embodiment of a sentiment analysis method which lists all the important blocks in computing the sentiment scores from online reviews;

FIG. 2 illustrates the set of reviews annotated by attribute/polarity combination after text clustering in accordance with the present invention;

FIG. 3 is a snapshot of another embodiment of displaying the highlighted text portion of reviews which reflects the sentiment contained in it in accordance with the present invention;

FIG. 4 illustrates the set of reviews grouped by clusters in a treemap view in accordance with the present invention.

### DETAILED DESCRIPTION

The invention will be described primarily as a computer-implemented method and system for extracting unstructured data of reviews and transforming it into structured data from text documents. However, persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program means for executing the operations of the invention.

Also, an article of manufacture, such as a pre-recorded disk or other similar computer program product, for use with a data processing system, could include a storage medium and program means recorded thereon for directing the data processing system to facilitate the practice of the method of the invention. Such apparatus and articles of manufacture also fall within the spirit and scope of the invention.

A primary goal of the invention is to identify the sentiments in individual statements of the document rather than just detecting the overall positive or negative sentiment of the subject. The existence of statements expressing sentiments is more reliable compared to the overall opinion of a document. The information in user reviews can easily be mined for insights by using the herein disclosed automated system, and these insights could be presented in an easily-understandable graphical manner to the user—thereby allowing to instantly receive the full depth of knowledge and information about a product (as contained in its reviews), without having to manually process all the information.

As per an exemplary embodiment, the present invention relates to a system for processing sentiment-bearing text. In one embodiment, the system identifies, extracts, clusters and analyzes the sentiment-bearing text and presents it in a way which is highly useable by the user. While the present invention can be used to process any sentiment-bearing text, the present description will proceed primarily with respect to processing product review information provided by consumers or reviewers of products. However, that exemplary context is intended to in no way limit the scope of the invention. Prior to describing the invention in greater detail, one illustrative environment in which the invention can be used will be discussed. The essential part of sentiment analysis is to identify how the sentiments are expressed in texts and whether the expressions indicate positive (favorable) or negative (unfavorable) opinions toward the subject. Conceptually, a method for extracting the sentiments from a document involves following steps—

Step 1—Analysis of Reviews Using Sentiment Engine

This step converts the unstructured data of reviews into structured data, that can be used for the visualisation. The machine learning techniques are used to do sentiment analysis of the user reviews. At the end of this step, we achieve the following—
1. The product attribute is detected (e.g.—in case of smartphones—battery, or camera, or display, or processor) that is being described in the review. For accomplishing this machine learning and natural language processing techniques are used. The polarity of the sentiment (positive/negative/neutral) in the review is also detected. As a result of this step, have every review annotated by the detected attribute class/sentiment class combination—(for e.g. battery negative, camera positive etc.)
2. The text fragments that generate this positive or negative sentiment are simultaneously detected for the detected attribute, using machine learning techniques. For e.g. “battery gets heated up” can be defined as a key phrase for detection of “battery negative class”.

Thus at the end of step one, for each product, A list of reviews that is annotated is generated by a combination of attribute-sentiment polarity and the keywords that generated that combination.

Step 2—Aggregating/Annotating the Output of Sentiment Engine Analysis

At the beginning of this step, the generated list of reviews for each product that are grouped by sentiment polarity and attribute type. For e.g., under “battery negative” which may have over 300 reviews, while under “display positive” may have another 500. These 300 reviews are also too many to process visually, even though they have been organized thematically. Therefore, at this step, we further simplify the structure of the data by grouping the reviews under each attribute/sentiment combination using a clustering algorithm. The clustering algorithm does a semantic clustering of the reviews under each attribute sentiment combination, using the highlighted text fragment as inputs.

For e.g, if there are 6 reviews which have the following sets of detected keywords—“battery gets heated up”, “heating problem in battery”, “battery too hot”, “extreme heating battery”, “battery heating is a big pain”, “major battery heating issue” etc, they will be assigned to the same cluster. Every cluster has a unique cluster ID, and a number of elements associated with it (six in the above case). The clusters detected above, are named, in an intuitive way so that the user is able to understand easily.

Now, a list of attributes (e.g. camera, battery etc. in case of smartphones) is generated, and for each attribute we have two groups of reviews (positive and negative) and under each group, we have a further grouping based on the keywords detected. This grouping can elegantly be conveyed on a treemap visualization.

Step 3—Displaying the Annotated Output in a Tree-Map Visualization

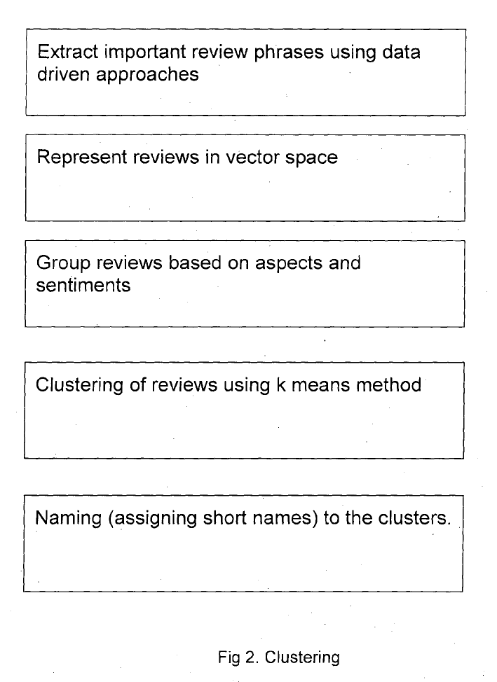

The data thus annotated, is now ready to be displayed on a treemap visualization (see working examples as shown in FIGS. 2 & 4). The tree map clearly conveys the data about all reviews. Users can click on a particular cluster and navigate to read the full text of reviews under that cluster, if they choose to. The summary visualization encapsulates all the information in the reviews in a succinct manner.

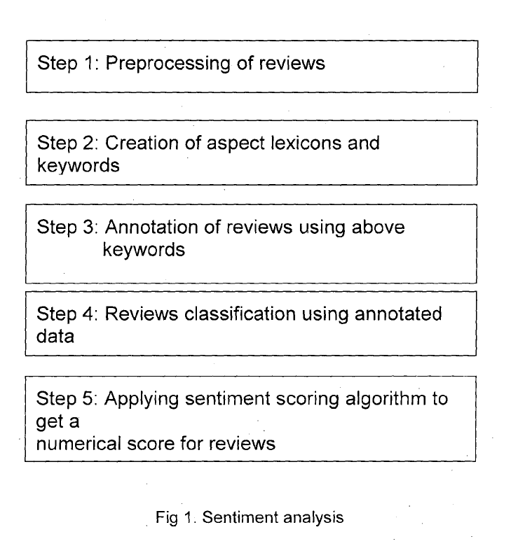

As shown in FIG. 1, the machine learning approaches to do sentiment analysis on user reviews and expert reviews. There are several steps in processing of reviews and a brief summary of the stages in pipeline is—
Pre-processing of reviews—Pre-processing of data is often less appreciated part, but it is very important for the later stages.
   a. Removal of duplicate reviews, i.e remove multiple reviews which have the same review text and review id and belong to the same mobile phone.
   b. Carrying out language identification to filter out the statements/sentiments which are not written in English.
   c. Training a supervised classifier using Naive Bayes algorithm (Manning, 2008) for sentence boundary detection according to (Gillick, 2009) and split the review to its individual sentences.
   d. Tokenizing of the sentences to remove non-english characters, separate punctuation characters from words etc. Spelling correction of misspelled words is done according to (Manning, 2008).
Creation of sentiment and aspect lexicons—Aspect based sentiment analysis on user reviews is carried out using machine learning and natural language processing. Supervised machine learning algorithms needs labelled data for training. The steps to generate labelled training data in semi-supervised setting are as below:
   a. Extraction of keywords for all sentiment and aspect classes from reviews to build lexicon files. These lexicons are used to do data annotation in reviews.
   b. Extraction of the keyword phrases from the reviews corpus using unsupervised statistical language modelling techniques as described in (Shailesh, 2014).
   c. Generation of a representation of words and phrases in vector space commonly known as word embeddings as described in (Mikolov, 2015).
   d. To grow the said lexicons, a semantic graph is constructed, using the cosine similarity between words and phrases embeddings as the similarity criterion. Few seed words of each class are used to come up with more similar keywords using similarity based graph propagation algorithm.
   e. After several iterations of graph propagation algorithm, majority of the aspect can be extracted with sentiment based keywords.
Data annotation (labelling) using above keywords—These lexicons are used for every class to annotate the review sentences as below:
   a. In every review sentence, the presence of aspect and sentiment words are searched. After parsing the sentence, the sentiment word which is closest to the aspect word is selected and the sentence is tagged with the corresponding aspect, sentiment tuple.
   b. In case if multiple similar tags gets associated with a sentence, fine tuning is carried out with the aspect and sentiment tags, by using maximum probability score among all tags by language modelling of corresponding sentence texts.
   c. If we detect negation inducing words like {don't, can't. etc} around the surrounding context of aspect words, the polarity of the corresponding sentiment is reverted.
   d. the annotated data is organized into its aspect class followed by its sentiment class.
Aspect and sentiment classifier—The machine learning approaches is used to predict the aspect class and sentiment class by using labelled review sentences in following steps.
   a. training an aspect classifier to predict the correct aspect class followed by sentiment classifier for fine grained sentiment analysis.
   b. learning a mixture of vector embedding for every aspect class based on generative model of sentences. The mixture of vector embedding is used per class to predict the aspect class on unseen review sentences.
   c. selecting those sentences which were correctly classified above for training of sentiment classifier.
   d. carrying out fine grained sentiment classification, i.e there are five sentiment classes which are most-positive, positive, neutral, negative, most-negative.
   e. using term-frequency, inverse document frequency, bigram and key phrases as features for the logistic regression based sentiment classifier.
   f. selecting those review sentences for which the sentiment classifier prediction agrees with the labelled data which is commonly known as diagonal elements of the classifier confusion matrix.

Sentiment Score Computation:—
fine graining of the sentiment scoring with five category types or classes which are most-positive, positive, neutral, negative and most-negative.
providing weights to each of the fine grained sentiment levels in descending order of importance as below.
   {most-positive: 1.5, positive: 1, neutral: 0, negative: −1, most-negative: −1.5}
computing the sentiment score of each aspect for every mobile phone by aggregating the weighted confidence score of the sentiment classifier for that aspect. Then we normalize the aggregated score by the frequency count of reviews for that aspect followed by min-max rescaling of the normalized score as below.
   do
   for ‘m’ in mobile phone:
      for ‘a’ in aspect type:

$$raw score ( a , m ) = {\sum }_{reviews} I ( mobile phone = m , aspect type = a ) * ( sentiment weight ) * ( conf score )$$

$$normalized score ( a , m ) = \frac{raw score}{{Σ}_{reviews} I ( mobile phone = m , aspect type = a )}$$

$$percentage score ( a , m ) = \frac{( normalized score - ( most - negative ) ) * 100}{( ( most - positive ) - ( most - negative ) )}$$

done
Using the sentiment score of every aspect, we calculate the sentiment score of a mobile phone by the average of its aspects sentiments score, as below
   do
   for ‘m’ in mobile phone:

sentiment score(m)=(Σ_{aϵaspects} percentage score(a,m))/|aspects|
done
computing the total score for every aspects by the average of their sentiment score and specification score. Then, average is calculated over the total aspects score for all aspects to compute the total score of a mobile phone.
   do
   for ‘m’ in mobile phone:
      for ‘a’ in aspect type:
   if sentiment score(a, m) exists:

total score(a,n)=(sentiment score(a,m)+specification score(a,m))/2

else:

$$total score ( a , m ) = specification score ( a , m ) * ( sentiment smoothing ( m ) ) \\$$

$$total score ( m ) = ( {\sum }_{a ∈ aspects} total score ( a , m ) ) \text{/} \vert aspects \vert$$

done

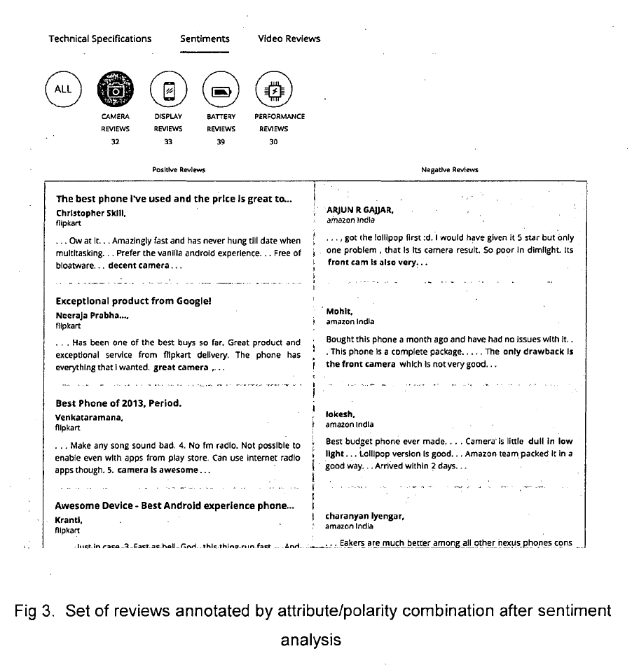

As shown in FIG. 3, the clustering of reviews annotated by attribute/polarity combination after sentiment analysis in accordance with the present invention;

Clustering of Review Fragments
A. The important phrases are extracted in the corpus using data driven approach as mentioned in Kumar (2014) and annotate the corpus with phrases. For example, the words mobile handset becomes mobile_handset etc.
B. The reviews are represented in vector space by their dense semantic embedding. These embeddings are created using, distributed bag of words approach (DBOW) in which the word embeddings and review embeddings are jointly learned (Le et al, 2014). In DBOW method, each review is represented by its review id and the review id co-occurs with every word in the review. The word and review embeddings are learnt using skip-gram method following Mikolov et al (2014). The objective function we maximize is as below:
   Σᵢ₌₁^{N}^{ₛ} Σ_{ca[-w,w],c=0} log p(w_{i+c}/wᵢ)+Σᵢ₌₁^{N}^{ₛ} log p(wᵢ/rⱼ)
   where p(w_{i+c}/wᵢ) is defined as

$$p ( {w}_{i + e} \text{/} {w}_{i} ) = \frac{exp ( {v}_{wi}^{T} {v}_{{w}_{i} + c}^{′} )}{{Σ}_{w = 1}^{i} {exp ( {v}_{{w}_{i}}^{T} {v}_{w}^{′} )}^{′}}$$

wᵢ denotes the current word, w_{i+c} denotes the context word within a window of size w. Nₛ is the number of words in sentence (corpus), rⱼ is the jth review id, T is the number of unique words selected from the corpus in the dictionary, v_{w}_{ᵢ} is the vector representation of the current word from the inner layer of the neural network, v_{w+c}′ is the vector representation of the context word from the outer layer of the neural network.
C. Aspect classification is carried out followed by sentiment classification of reviews into 8 categories using supervised machine learning algorithms. These categories are {‘camera-positive’, ‘camera-negative’, ‘battery-positive’, ‘battery-negative’, ‘display-positive’, ‘display-negative’, ‘performance-positive’, ‘performance-negative’}. So, each review sentence gets assigned to one of the above categories.
D. Clustering of reviews is carried out using K-Means method for each of the above categories to group similar meaning review fragments in a cluster. The objective function we minimize in k-means clustering is argminΣᵢ₌₁^{k} Σ_{xϵS}∥x−uᵢ∥, where xᵢ is the feature vector of review fragment, uᵢ is the centroid vector to be learned.
E. Assigning short names to every cluster which are to be displayed in treemap view. These cluster names are stored in a hash table in which the review fragment are the keys and the cluster names are the values.

Diverse Reviews
a. Few sample reviews are displayed for every aspect in treemap view and highlight those text regions in a review which mentions the corresponding aspects. We show reviews which cover varied sub-aspects and are diverse in terms of text highlighted in them.
b. The text regions from review sentences are found which activates the aspect and sentiment classifier the most for all the reviews.
c. In order to find diverse reviews, clustering of text regions are carried out from above for each aspect and sentiment type of every subject as below:
   i. Applying of the k-means++ algorithm (Arthur et al., 2007) to do the text clustering.
   ii. Number of clusters is taken as the square root of number of reviews.
   iii. For each cluster the text data closest to its centroid is selected. The selected text data are sorted according to sentiment classifier confidence score and at maximum 20 reviews are selected.

Treemap View
a. For every review in an aspect and sentiment type of a mobile phone(i.e. categories mentioned above, The cluster name using the hash table is recorded. The frequency of occurrence of every cluster name is calculated by aggregating the cluster names for all the reviews.
b. In the treemap display, the size of text box is adjusted according to the frequency of the cluster calculated above. On navigation to the treemap box, the highlighted review is shown which it contains.

### Advantages of Proposed Solution

The proposed solution has the following benefits—
Saves time for consumers/Resolves information overload: Users no longer have to sift through hundreds and thousands of reviews, since the entire information contained in all those reviews is displayed in a single visualization that gives users a complete overview of the product. Resolving information overload helps in saving time for consumers.
Provides complete product information: Since the automated system mines information from the entire body of reviews, the resulting information is comprehensive and representative of all the information contained in all the user reviews.
Enhanced user experience: The ability to view all the insights, about a product at a single glance, instead of navigating through several pages of reviews, leads to a superior user experience. We also achieve a superior user experience by converting unstructured data into structured information that is easy to interpret and reusable across systems.

### Working Samples

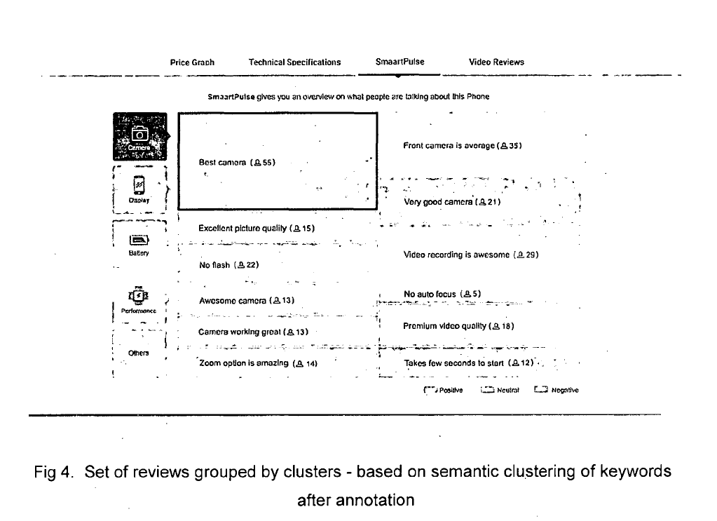

E.g. Smartphone user reviews
1. There are over thousands of reviews for each smartphone product across various e-commerce websites.
2. Each smartphone can be considered as being composed of the following 4 attributes (A1 to A4)—namely camera, battery, display and processor.
3. Each of these reviews may describe one or more of the above attributes and may have a positive or negative polarity associated with it.
4. Each review is processed by the sentiment analysis algorithm which detects the said attributes per review and the associated polarity with those attributes. The algorithm also detects the keywords that generate the above polarity/attribute combination (see FIG. 2).
5. The clustering algorithm uses the detected keywords as a basis to perform a semantic clustering of the reviews.
6. Each semantically generated cluster is named appropriately based on its constituent elements.
7. The final data set—with reviews grouped under attribute/polarity type and sub-grouped by well-named semantic clusters—is displayed as a treemap visualization.
8. The entire information of the reviews is available in a single treemap that can be easily interpreted by users (see FIG. 4).

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What claims is:

1. A computer-implemented method for evaluating user reviews over distributed documents of a product comprising the steps of:
[STEP 1] extracting and analyzing of user reviews using sentiment engine;
[STEP 2] aggregating/annotating the output of sentiment engine analysis; and
[STEP 3] displaying the annotated output in a tree-map visualization.

2. A computer-implemented method for evaluating user reviews as claimed in claim 1 wherein, under step 1 the unstructured data of reviews are converted into structured data, which is used for the visualisation.

3. A computer-implemented method for evaluating user reviews as claimed in claim 1 wherein, under step 2 the machine learning and natural language processing techniques are used for the sentiment analysis of the user reviews and the polarity of the sentiment (positive/negative/neutral) in the review is detected.

4. A computer-implemented method for evaluating user reviews as claimed in claim 3 wherein, the key phrases that generate positive, negative or neutral sentiments are simultaneously detected for the detected attribute, using machine learning techniques.

5. A computer-implemented method for evaluating user reviews as claimed in claim 4 wherein, the generated list of reviews for each product are grouped by sentiment polarity and attribute type.

6. A computer-implemented method for evaluating user reviews as claimed in claim 1 wherein, the data about all reviews are displayed in the form of tree map configured for navigation.

7. A computer-implemented method for evaluating user reviews as claimed in claim 1 wherein, the machine learning approaches for sentiment analysis on user reviews further comprises the steps of:
(i) pre-processing of reviews;
(ii) creation of sentiment and aspect lexicons;
(iii) data annotation (labelling) using above key phrases;
(iv) classifying of the aspect and sentiment from user reviews;
(v) providing scores to the sentiments from user reviews; and
(vi) displaying the reviews in chronological orders.

8. A computer-implemented method for evaluating user reviews as claimed in claim 7 wherein, the pre-processing of data further comprise the steps of:
a. removing of the duplicate reviews which have the same review text and review identity;
b. carrying out language identification to filtering out the statements/sentiments which are not written in English;
c. training of a supervised classifier using Naive Bayes algorithm for sentence boundary detection and splitting of review to its individual sentences; and
d. tokenizing of the sentences for removing non-english characters, separate punctuation characters from words, spelling correction of misspelled words.

9. A computer-implemented method for evaluating user reviews as claimed in claim 7 wherein, the step of creation of sentiment and aspect lexicons further comprises the steps of:
e. extraction of keywords for all sentiment and aspect classes from reviews to build lexicon files which are used for carrying out data annotation in reviews;
f. extraction of the keyword phrases from the reviews corpus using unsupervised statistical language modelling techniques;
g. generating a representation of words and phrases in vector space commonly known as word embeddings;
h. growing of the said lexicons files for the construction of a semantic graph using the cosine similarity between words and phrases embeddings as the similarity criterion based graph propagation algorithm; and

10. A computer-implemented method for evaluating user reviews as claimed in claim 8 wherein the data annotation (labelling) using key phrases is carried out comprising the steps of:
j. searching of the presence of aspect and sentiment words in every review sentence, and after parsing the sentence, the sentiment word which is closest to the aspect word is selected and thereafter tagging of the sentence with the corresponding aspect, sentiment tuple;
k. carrying out fine tuning with the aspect and sentiment tags, by using maximum probability score among all tags by language modelling of corresponding sentence texts under condition if multiple similar tags gets associated with a sentence;
l. reverting the polarity of the corresponding sentiment under condition that negation inducing words like {don't, can't. etc} are detected around the surrounding context of aspect words; and
m. organizing the annotated data into its corresponding aspect class followed by its sentiment class.

11. A computer-implemented method for evaluating user reviews as claimed in claim 8 wherein the classification of the aspect and sentiment from user reviews comprising the steps of:
n. training an aspect classifier to predict the correct aspect class followed by sentiment classifier for fine grained sentiment analysis;
o. learning a mixture of vector embedding for every aspect class based on generative model of sentences and is used per class to predict the aspect class on unseen review sentences
p. selecting those sentences which were correctly classified above for training of sentiment classifier;
q. carrying out fine grained sentiment classification, i.e there are five sentiment classes which are most-positive, positive, neutral, negative, most-negative using term-frequency, inverse document frequency, bigram and key phrases as features for the logistic regression based sentiment classifier; and
r. selecting those review sentences for which the sentiment classifier prediction agrees with the labelled data.

12. A computer-implemented method for evaluating user reviews as claimed in claim 8 wherein, the step of providing scores to the sentiments from user reviews, with five category types or classes which are most-positive, positive, neutral, negative and most-negative further comprising the steps of:
s. providing weights to each of the fine grained sentiment levels in descending order of importance using formula as:
{most-positive: 1.5, positive: 1, neutral: 0, negative: −1, most-negative: −1.5}
t. computing the sentiment score of each aspect for every mobile phone by aggregating the weighted confidence score of the sentiment classifier for that aspect and thereafter normalizing the aggregated score by the frequency count of reviews for that aspect followed by min-max rescaling of the normalized score using formula as:
for ‘m’ in mobile phone:
for ‘a’ in aspect type:
$$raw score ( a , m ) = {\sum }_{reviews} I ( mobile phone = m , aspect type = a ) * ( sentiment weight ) * ( confidence score )$$
$$normalized score ( a , m ) = \frac{raw score}{{Σ}_{reviews} I ( mobile phone = m , aspect type = a )}$$
$$percentage score ( a , m ) = \frac{( normalized score - ( most - negative ) ) * 100}{( ( most - positive ) - ( most - negative ) )} \\$$
u. calculating the sentiment score of a product by the average of its aspects sentiments score using the sentiment score of every aspect using formula as:
for ‘m’ in mobile phone:
sentiment score(m)=(Σ_{aϵaspects} percentage score(a,m))/|aspects|

v. computing the total score for every aspects by the average of their sentiment score and specification score, thereafter average is calculated over the total aspects score for all aspects to compute the total score of a product using formula as:
for ‘m’ in mobile phone and
for ‘a’ in aspect type:
if sentiment score(a, m) exists:
total score(a,m)=(sentiment score(a,m)+specification score(a,m)))/2
else
$$total score ( a , m ) = specification score ( a , m ) * ( sentiment smoothing ( m ) )$$
$$total score ( m ) = ( {\sum }_{a ∈ aspects} total score ( a , m ) ) \text{/} \vert aspects \vert$$

13. A computer-implemented method for evaluating user reviews as claimed in claim 8 wherein, the displaying the reviews for every aspect and highlighting those text regions in a review which mentions the corresponding aspects comprising the steps of:
displaying reviews which cover varied sub-aspects and are diverse in terms of text highlighted in them;
providing the text regions from review sentences which activates the aspect and sentiment classifier the most for all the reviews.
clustering of text regions is carried out from above for each aspect and sentiment type of every phone in order to find diverse reviews, as below:
i. the k-means++ algorithm is applied to do the text clustering;
ii. Number of clusters is taken as the square root of number of reviews;
iii. For each cluster the text data closest to its centroid is selected;
selecting the reviews for display in website after further curation.

14. A system for evaluating user reviews over distributed documents of a product, comprising of:
at least one processor and a display;
at least one non-transitory computer readable medium storing instructions translatable by the at least one processor to implement the steps of:
[STEP 1] extracting and analyzing of user reviews using sentiment engine;
[STEP 2] aggregating/annotating the output of sentiment engine analysis; and
[STEP 3] displaying the annotated output in a tree-map visualization.

15. A system for evaluating user reviews as claimed in claim 14 wherein, under step 1 the unstructured data of reviews are converted into structured data, which is used for the visualisation.

16. A system for evaluating user reviews as claimed in claim 14 wherein, under step 2 the machine learning and natural language processing techniques are used for the sentiment analysis of the user reviews and the polarity of the sentiment (positive/negative/neutral) in the review is detected.

17. A system for evaluating user reviews as claimed in claim 16 wherein, the key phrases that generate positive, negative or neutral sentiments are simultaneously detected for the detected attribute, using machine learning techniques.

18. A system for evaluating user reviews as claimed in claim 17 wherein, the generated list of reviews for each product are grouped by sentiment polarity and attribute type.

19. A system for evaluating user reviews as claimed in claim 18 wherein, on using the key phrases as inputs a semantic clustering of the reviews under each attribute sentiment combination, is carried out.

20. A system for evaluating user reviews as claimed in claim 19 wherein, the detected clusters, are named, in an intuitive way.

21. A system for evaluating user reviews as claimed in claim 14 wherein, the data about all reviews are displayed in the form of tree map configured for navigation.
